(19) United States
(12) Patent Application Publication
(10) Pub. No.: US 2008/0016772 A1
(43) Pub. Date: Jan. 24, 2008

(54) Revolving Door

(75) Inventor: Manfred Rockenbach, Frechen (DE)

Correspondence Address: COHEN, PONTANI, LIEBERMAN & PAVANE, 551 FIFTH AVENUE, SUITE 1210, NEW YORK, NY, 10176, US

(73) Assignee: Dorma GmbH + Co. KG, Ennepetal (DE)

(21) Appl. No.: 11/587,608

(22) PCT Filed: Apr. 19, 2005
(86) PCT No.: PCT/EP05/04159

§ 371 Date: Nov. 17, 2006

(30) Foreign Application Priority Data
Apr. 29, 2004 (DE) 10 2004 021 309.7

(51) Int. Cl. E06B 3/90

(52) U.S. Cl. 49/42

(57) ABSTRACT

A revolving door comprising a rotating device operable to rotate in a direction of rotation; exterior stationary drum walls surrounding the rotating device and defining two passageways, each drum wall having a front edge facing the direction of rotation; at least two rotating door leaves disposed within the drum walls and attached to the rotating device, each door leaf having a side facing away from the rotating device; and a pivotable portion which is pivotably attached to the side of each door leaf. If a user is being jammed between the front edge of a drum wall and the pivotable portion of a door leaf, a predetermined resistance of the jamming makes the pivotable portion to pivot relative to the door leaf, thereby clearing a space between the front edge of the drum wall and the pivotable portion of the door leaf to prevent the user from being jammed.

### DESCRIPTION

The invention relates to a revolving door with exterior stationary drum walls having two passageways, and with a rotating device, which is disposed within the surrounding drum walls and comprises at least two rotating door leaves.

Such revolving doors are well known. In addition to manually operable revolving doors, other revolving doors with an electrical motor drive are known, in particular with a fully automatic, micro-processor controlled drive system.

On the outside, the known revolving doors have two stationary drum walls, which include two passageways, generally located diametrically opposite to each other. These two passageways, so to speak, form the “lockage” area of the revolving door. A rotating device, which has a rotating part with two, three or four leaves, is located within these round drum walls, such that door leaves directly or indirectly extend from a central vertical axis. This rotating device is driven by means of an electrical motor to perform a rotational movement, such that the door leaves rotate and, with their ends pointing to the outside, terminate with the inside faces of the curved drum walls. One problem encountered with this type of revolving doors consists in shearing edges existing between the front edge of the drum wall in the area of a passageway and the door leaves, between which edges the users might get jammed and thus injured, when the door leaves rotate. Therefore, such revolving doors need to be equipped with appropriate safety devices, such that, in the event a user gets jammed, the rotating device abruptly stops. In an emergency situation, this stopping operation is not easy to perform and in addition it causes a lot of stress to the material. In known revolving doors, safety devices in the shape of safety contact strips are usually provided at the shearing edges, which, upon deformation, trigger an electrical alarm. Thus, for the case a user gets jammed, the known revolving doors have a safety device, which by the way works very reliably; however, technically it is very difficult to realize the abrupt stop of the rotating device. In particular for large revolving doors this is only possible at important technical expenditure.

In particular for children or toddlers, the risk of getting jammed is very high, as they do not yet have enough body force to possibly resist the door. Therefore, in particular children and toddlers are at risk to injure themselves, if they get jammed in the interspace between the front edge of the drum wall in the area of a passageway and the associated door leaf.

Based on the foregoing, the object of the invention is to provide an improved revolving door, which has a more efficient anti-jamming protection in particular for children, and causes less material stress.

According to the invention, this problem is solved for a revolving door with exterior, stationary drum walls having two passageways, and with a rotating device, which is disposed within the surrounding drum walls and comprises at least two rotating door leaves, in that each door leaf has a portion, which is pivotable about a vertical axis.

An efficient anti-jamming protection is provided by means of this embodiment. As soon as a person could be at risk to get jammed in the interspace between the front edge of the drum wall in the area of a passageway and the door leaf, the pivotable portion can pivot aside and thus clears a space between the front edge of the drum wall and the door leaf, such as to eliminate a possible formation of shearing edges. This circumstance not only allows to effectively avoid injuries, but also to reduce the dimensions of the overall structural arrangement, because an abrupt stopping of the door is no longer mandatory. In particular with revolving doors having a very large diameter, the overall structural expenditure is considerably reduced and thus leads to cut cost.

Advantageous further developments will result from the dependent claims.

As the shearing edges are formed between the front edge of the drum wall in the area of a passageway and the associated door leaf, it is intended, according to a preferred further development, that the pivotable portion be disposed at the side of the door leaf oriented towards the drum wall. As a result, if a person is at risk to get jammed between the drum wall and the associated leaf door, the pivotable portion can pivot aside, such that shearing edges are no longer formed between the drum wall and the associated leaf door.

The risk of getting jammed can be furthermore reduced in that the pivotable portion is pivotable in opposite direction to the direction of rotation. The pivotable portion can pivot backwards and thus clears enough space to avoid forming shearing edges.

According to a preferred embodiment, the door leaf and the pivotable portion may have the same structure. Usually, the leaf doors consist of a frame, into which a glass pane is inserted. This structure may be reproduced in the pivotable portion, which will have a frame with a glass pane as well. However, the frame may not exist on the sides of the leaf door and of the pivotable portion pointing towards each other, such that the two glass panes are located very close to each other without a frame therebetween. A uniform appearance of the entire door leaf is achieved through the inventive subdivided revolving door without being visually disturbing.

As an alternative, the door leaf and the pivotable portion may have a different structure, e.g. if it is intended to bring the critical areas into focus. Thus, it is conceivable to build the door leaf, in a known way, from a frame and an inserted glass pane, whereas the pivotable portion is made from a different material or has a another shape or another design, e.g. opaque.

As the risk of getting jammed is the highest for children or toddlers in particular, it is intended, according to a preferred embodiment, that the pivotable portion has at least the width of a child's body. Therefore, especially no child can get jammed between the drum wall and the leaf door.

In known manner, the termination between the pivotable portion and the drum wall will be formed by means of a brush provided at the front side of the pivotable portion oriented to the drum wall.

Advantageously, in its initial position, the pivotable portion is substantially aligned with the door leaf. Such embodiment is advantageous in that, in the normal state, the pivotable portion acting as a safety device is barely visible and thus is not perceived as disturbing.

Preferably, the pivotable portion is provided with a resetting device, which will urge the pivotable portion back to the initial position thereof. After pivoting, the pivotable portion will thus automatically return to the initial state thereof. Suitable possible resetting devices are e.g. a spring, a torsion bar, etc.

In order to create sufficient free space, the pivotable portion is pivotable by about 90°, such as, in the fully pivoted position, to substantially extend normally from the leaf door.

According to an advantageous embodiment, the pivotable portion may have flat front and back faces and almost invisibly blend in with the revolving door.

According to an alternative embodiment, the pivotable portion may also have a convexly curved front face. This in particular is an advantage, because such a curved surface, in a sense, allows a person to roll off and slide along the pivotable portion.

A particularly visually appealing form of the pivotable portion is achieved, if the pivotable portion further has a concavely curved rear face. In cooperating with the convexly curved front face, a slightly arched pivotable portion is achieved, which, from a visual point of view, accentuates the direction of rotation of the revolving door.

In order to prevent the pivotable portion from pivoting uncontrolled back and forth, according to a preferred further development, it is intended, that the pivotable portion is pivotable out of its initial position against a resistance. Such a resistance may be achieved for example by means of a snap-in groove or the like, into which a corresponding cam catch engages. In order to pivot the pivotable portion out of the initial position thereof, the cam catch needs to be moved out of the snap-in groove, prior to be able to pivot the pivotable portion.

The resistance, which is required to pivot the portion, may be conceived to be adjustable, in order the pivotable portion be responsive to children and toddlers.

Depending on the embodiment, the pivotable portion may be made from rubber, metal, plastic material, glass or the like, such as to be able to consider architectural and visual aspects as well.

According to another embodiment, a sensor strip can be disposed at a front edge of the drum wall located at the front in the direction of rotation, which strip, as soon as the door leaf encounters an obstacle present in the area of rotation or upon mechanical contact with such obstacle, stops the movement of the revolving door. This measure can even further enhance the safety of the inventive revolving door.

Further features and advantages of the invention will become apparent from the following description of one preferred exemplary embodiment, in which:

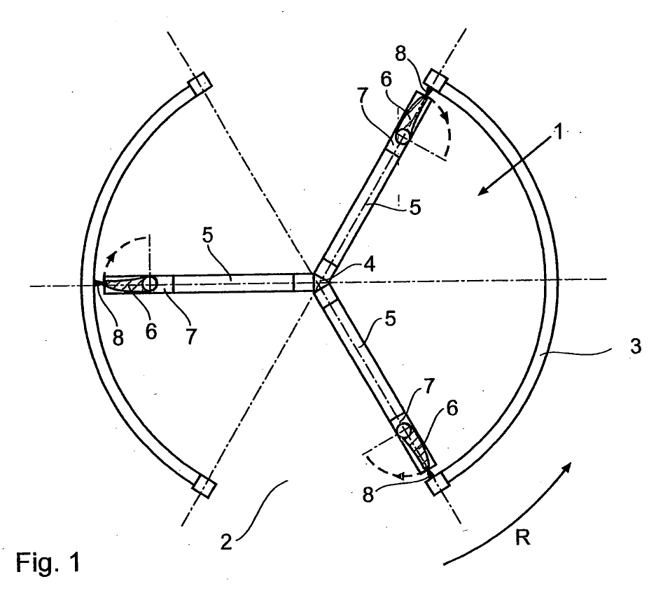

FIG. 1 shows a diagrammatic view from the top on an inventive revolving door,

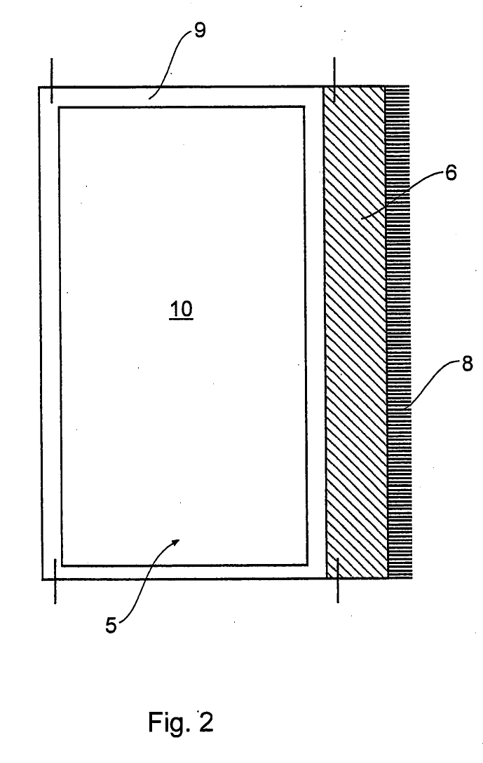

FIG. 2 shows a diagrammatic view of a door leaf formed according to the invention, and

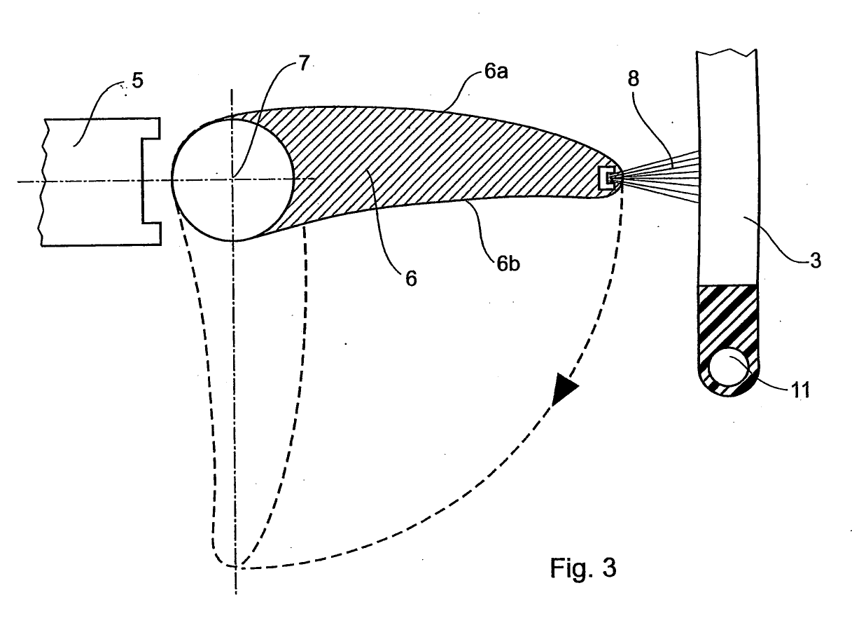

FIG. 3 shows a detailed view of a door leaf door leaf formed according to the invention in the area of the drum wall.

In the illustration, only the relevant parts are depicted, all other structural components have been omitted for clarity's sake.

An inventive revolving door 1 is diagrammatically illustrated in a top view in FIG. 1. The revolving door 1 has exterior stationary drum walls 3, which have two passageways 2 (only one being illustrated). A rotating device 4 with three rotating door leaves 5 is disposed within the drum walls 3. The illustrated revolving door 1 is a revolving door 1 with three door leaves 5. However, the invention can be applied to revolving doors 1 having two leaves or four leaves.

The illustrated revolving door 1 has a counter-clockwise direction of rotation R. Naturally, the invention can be applied to revolving doors 1 which rotate clockwise.

Each individual door leaf 5, at the side thereof oriented towards the drum wall 3, is provided with a portion 6, which can be pivoted preferably by about 90° exclusively in opposite direction to the direction of rotation R of the revolving door 1 about a vertical axis 7 and extends over the entire height of the door leaf 5. The pivotable portion 6 cannot pivot in the direction of rotation R, in order to allow pushing this portion 6 without moving it out of the initial position thereof, when manually operating the revolving door 1.

At the edge thereof oriented towards the drum wall 3, the pivotable portion 6 is provided with a brush 8, which sweeps along the drum wall 3 and forms a wind tight termination.

In the initial position thereof illustrated in FIG. 1, the pivotable portion 6, having the width of a child's body, is substantially aligned with the door leaf 5. In this initial position, the pivotable portion 6 is retained in the initial position thereof e.g. via a snap-in device, counteracting a movement such that the pivotable portion 6 cannot move uncontrolled in opposite direction to the direction of rotation R. In order to guarantee an early pivoting of the pivotable portion 6 in the event of jamming, the snap-in device resistance that needs to be overcome is adjustable. This makes sure that the safety device formed by the pivotable portion 6 is likewise responsive to a child or a toddler.

In order for the pivotable portion 6 to return automatically into the initial position thereof, it is equipped with a resetting device, which urges the pivotable portion 6 back into the initial position thereof. The resetting device can be formed e.g. by a spring, a torsion bar or the like.

In the illustrated exemplary embodiment, the pivotable portion 6 has a different structure than the door leaf 5. While for example the door leaf 5 is formed by a frame 9 surrounding a glass pane 10, the pivotable portion 6 may be made e.g. from rubber, metal, plastic material, glass or the like. Furthermore, the pivotable portion 6 has a convexly curved front face 6a and a concavely curved back face 6b, such that if, in the event of danger, the portion 6 is pivoted in opposite direction to the direction of rotation R, the body of a jammed person may roll off the rounded front face 6a.

However, as an alternative, the door leaf 5 and the pivotable portion 6 as well may have the same structure and have e.g. a substantial flat front face 6a and back face 6b.

In addition to the described embodiment with a door leaf 5 including a pivotable portion 6, a sensor strip 11, which, after the door leaf 5 hits an obstacle in the area of rotation, stops the movement of the revolving door 1, may be provided at the front edge of the drum wall 3 located at the front in the direction of rotation R.

### LIST OF REFERENCE NUMERALS

1 revolving door
2 passageway
3 drum wall
4 rotating device
5 door leaf
6 pivotable portion
6a front face
6b back face
7 vertical axis
8 brush
9 frame
10 glass pane
11 sensor strip
R direction of rotation

1.-17. (canceled)

18. A revolving door comprising:
a rotating device operable to rotate in a direction of rotation;
exterior stationary drum walls surrounding the rotating device and defining two passageways, each drum wall having a front edge facing the direction of rotation;
at least two rotating door leaves disposed within the drum walls and attached to the rotating device, each door leaf having a side facing away from the rotating device; and
a pivotable portion pivotably attached to said side of each door leaf,
wherein said pivotable portion of one of the at least two door leaves pivots relative to the one of the at least two door leaves when an obstruction between the front edge of one of the drum walls and said pivotable portion of the one of the at least two door leaves exerts a predetermined resistance on said pivotable portion, thereby clearing a space between said front edge of the one of the drum walls and said pivotable portion of the one of the at least two door leaves.

19. The revolving door of claim 18, wherein each pivotable portion is pivotable relative to a respective door leaf in a direction which is opposite to the direction of the rotation.

20. The revolving door of claim 18, wherein each pivotable portion has a structure which is the same as a structure of a respective door leaf.

21. The revolving door of claim 18, wherein each pivotable portion has a structure which is different from a structure of a respective door leaf.

22. The revolving door of claim 18, wherein each pivotable portion has a width which is at least the same as a width of a child's body.

23. The revolving door of claim 18, wherein each pivotable portion has an edge facing the drum walls, and a brush attached to said edge and oriented toward the drum walls.

24. The revolving door of claim 18, wherein each pivotable portion, when in its initial position, is substantially aligned with a respective door leaf.

25. The revolving door of claim 18, wherein each pivotable portion is provided with a resetting device which urges said each pivotable portion back to its initial position after said each pivotable portion is pivoted relative to a respective door leaf.

26. The revolving door of claim 18, wherein each pivotable portion is pivotable by approximately 90° relative to a respective door leaf.

27. The revolving door of claim 18, wherein each pivotable portion has a substantially flat front face and a substantially flat back face.

28. The revolving door of claim 18, wherein each pivotable portion has a convexly curved front face.

29. The revolving door of claim 18, wherein each pivotable portion has a concavely curved back face.

30. The revolving door of claim 18, wherein each pivotable portion comprises at least one of rubber, metal, plastic and glass.

31. The revolving door of claim 18, further comprising a sensor strip provided at the front edge of each drum wall and facing the direction of rotation, said sensor strip being operable to stop movement of the revolving door upon mechanical contact with an obstacle.
